(19) United States
(12) Patent Application Publication
(10) Pub. No.: US 2014/0203901 A1
(43) Pub. Date: Jul. 24, 2014

(54) REACTOR AND ELECTRICAL DEVICE

(71) Applicants: Toshio Chamura, Narita-shi (JP); Yoshinobu Takayanagi, Tokyo (JP); Minoru Takahashi, Matsumoto-shi (JP)

(72) Inventors: Toshio Chamura, Narita-shi (JP); Yoshinobu Takayanagi, Tokyo (JP); Minoru Takahashi, Matsumoto-shi (JP)

(73) Assignee: TDK CORPORATION, Tokyo (JP)

(21) Appl. No.: 14/342,002

(22) PCT Filed: Aug. 27, 2012
(86) PCT No.: PCT/JP2012/071542

§ 371 Date: Feb. 28, 2014

(30) Foreign Application Priority Data
Aug. 30, 2011 (JP) 2011-187709

(51) Int. Cl. H01F 38/14

(52) U.S. Cl. CPC H01F 38/14
USPC 336/220

(57) ABSTRACT

To provide a small sized reactor with which it is possible to reduce the volume of a core and decrease electrical power losses.

[Solution] A reactor has a first magnetic body and a pair of mutually insulated coils insulated from the first magnetic body while being arranged so as to surround the first magnetic body, and positively coupled to each other in response to a signal input between one end of each coil. The first magnetic body has a first and a second end portions, and the first and the second end portions are formed without directly facing each other via a space where the first magnetic body does not exist, and an output signal is output from between the other end of each of the pair of coils on the basis of the input signal input between the one end of each of the pair of coils.

The present invention relates to a reactor, a electrical device which is used in a power conditioner for solar-power generation, etc.

### BACKGROUND

In recent years, with the popularity of a power conditioner, a reactor which is used in the power conditioner for solar power generation, etc. is asked to be low-cost and small sized from industry. Recently, in response to energy-saving, it is desired that a reactor with further high efficiency or material reduction for responding to resource-saving comes into being.

A existing reactor is commonly a structure of magnetic body with close magnetic circuit such as that in Patent 1, FIG. 10 is an example of the existing reactor. The reactor R4 comprises a first coil 101, a second coil 102, a first magnetic body a(103), a second magnetic body 104, a third magnetic body 105, a first magnetic body b(106), and a bobbin 109a, 109b of the existing reactor. In the FIG. 10, on the first magnetic body a(103) and the bobbin 109a of the existing reactor for assuring insulation from the coil, the first coil 101 is wound. On the first magnetic body b(106) and the bobbin 109b of the existing reactor for assuring insulation from the coil, the second coil 102 is wound. Furthermore, the bobbin 109a, 109b of the existing reactor are formed into U-shape so as to be configured with the first coil 101 and the second coil 102 respectively. The bobbin 109a of the existing reactor is installed around the first magnetic body a(103), the bobbin 109b of the existing reactor is installed around the first magnetic body b(106). Furthermore, the first coil 101 and the second coil 102, respectively, become a mutually insulated state by different winding wires. Furthermore, on one end of the first magnetic body a(103) and one end of the first magnetic body b(106), the second magnetic body 104 is arranged; on the other end of the first magnetic body a(103) and the other end of the first magnetic body b(106), the third magnetic body 105 is arranged. However, in this structure, making the first coil 101 close to the second coil 102 is difficult, the coupling degree m of the first coil 101 and the second coil 102 is commonly about m=0.5, it is impossible to make the coupling degree of the coil large enough. Furthermore, although there is magnetic flux leakage, because using the structure of close magnetic circuit, the magnetic flux arising out of the current flowing in the coil passes through the inner of the magnetic body which forms the close magnetic circuit, thus, electrical power losses of the magnetic body is generated. Furthermore, in order to get enough saturation magnetic flux of the magnetic body, it is necessary to make the magnetic body large sized. As a result, the problem that the reactor becomes large sized appears.

### PATENT DOCUMENTS

Patent 1: JP2009-259971 (TDK Corporation)

### SUMMARY

The purpose of the present invention is to provide a small sized reactor in which it is possible to reduce the volume of a core and decrease electrical power losses.

In order to accomplish the above-mentioned purpose, the present invention is a reactor, the reactor has a first magnetic body and a pair of mutually insulated coils insulated from the first magnetic body while being arranged so as to surround the first magnetic body, and positively coupled to each other in response to a signal input between one end of each coil. The first magnetic body has a first and a second end portions, and the first and the second end portions are formed without directly facing each other via a space where the first magnetic body does not exist, and an output signal is output from between the other end of each of the pair of coils on the basis of the input signal input between the one end of each of the pair of coils.

In order that the reactor is possible to decrease electrical power losses, the first magnetic body has a first and a second end portions, and the first and the second end portions are formed without directly facing each other via a space where the first magnetic body does not exist, and become a structure of open magnetic circuit, thus, because of reducing the volume of the magnetic body and the pair of coils are arranged so as to surround the first magnetic body, it is possible to get an effect that the reactor becomes small sized reactor.

As the preferable embodiment of the present invention, it is a reactor in which one coil of the pair of coils is covered by the other coil.

The reactor is a reactor in which one coil of the pair of coils is wound, and on the one coil the other coil is wound, thus, there is an effect that it is easy to wind the coil. Furthermore, because the pair of coils become overlapped structure, it is possible to make the volume of the magnetic body more small sized.

As the preferable embodiment of the present invention, it is also a reactor in which the pair of coils are arranged in parallel in the direction of the center line of the first magnetic body.

In the reactor, because the pair of coils are arranged in parallel in the direction of the center line of the first magnetic body, the stray capacitance between the coils becomes small, thus, it is possible to improve the frequency characteristic of the inductance in the pair of coils.

As the preferable embodiment of the present invention, it is also a reactor in which the pair of coils are bifilar winding wire.

In the reactor, the pair of coils are bifilar winding wire, thus, there is an effect that it is easy to wind the coil.

As the preferable embodiment of the present invention, it is a reactor in which the first magnetic body has a flange portion corresponding to the first magnetic body surrounded by the pair of coils, and the flange portion is insulated from the pair of coils.

In the reactor, the flange portion is arranged, thus, there is an effect of increasing inductance of the pair of coils.

As the preferable embodiment of the present invention, it is a reactor in which in manner of facing the first and the second end portions, a second and a third magnetic body of different material from the first magnetic body are arranged and connected.

In the reactor, it is possible to adjust inductance of the pair of coils.

As the preferable embodiment of the present invention, it is a reactor in which the second and the third magnetic body become flange portions corresponding to the first magnetic body covered by the coils, and the flange portions are insulated from the pair of coils.

In the reactor, according to the second and the third magnetic body arranged with the flange portions, there is an effect of increasing inductance of the pair of coils.

As the preferable embodiment of the present invention, it is a reactor in which the saturation magnetic flux density of the first magnetic body is larger than that of the second and the third magnetic body, the magnetic permeability of the first magnetic body is smaller than that of the second and the third magnetic body.

According to the reactor, even if in the case of increasing the current, there is also an effect that the reactor becomes a reactor in which the saturation magnetic flux density during the alternate current operation is high (that is, direct current overlap characteristic is excellent), and the inductance of the pair of coils is high.

As the preferable embodiment of the present invention, it is a reactor in which the coupling degree of between the pair of coils positively coupled to each other is 0.8 or above.

By increasing the coupling degree, there is an effect that it is possible to increase inductance of the pair of coils positively coupled to each other.

As the preferable embodiment of the present invention, it is a reactor in which the input signal is a plurality of plus and minus pulse signals, the output signal is alternate current signal.

In the reactor, the input signal is a plurality of plus and minus pulse signals, according to the reactor, there is an effect that it is possible to transfer the output signal into alternate current signal.

As the preferable embodiment of the present invention, it is a electrical device which has the reactor.

As a circuit comprising the reactor, there is a circuit which makes the switching waveform smooth, etc. Furthermore, as a device comprising the circuit, there is power conditioner or inverter power source, DC-DC converter, etc., which is possible to become all kinds of electrical devices.

In the reactor, the pair of coils are arranged so as to surround the first magnetic body. Furthermore, the volume of the magnetic body is reduced by the structure of open magnetic circuit, thus, the effect that the electrical power losses is reduced and the reactor becomes a small sized reactor can be obtained.

### BRIEF DESCRIPTION OF THE DRAWINGS

FIG. 1 is a sectioned diagram showing the reactor R1 of an embodiment of the present invention.

FIG. 2 is a sectioned diagram showing the reactor R2 of other embodiment of the present invention.

FIG. 3 is a sectioned diagram showing the reactor R3 of other embodiment of the present invention.

FIG. 4 is an example of other embodiment of the first magnetic body.

FIG. 5 is an example of other embodiment of the first magnetic body.

FIG. 6 is an example of other embodiment of the first magnetic body.

FIG. 7 is an example of other embodiment of the first magnetic body.

FIG. 8 is an example of other embodiment of the first magnetic body.

FIG. 9 is an example of other embodiment of the first magnetic body.

FIG. 10 is a sectioned diagram of the existing reactor R4.

FIG. 11 is a connection example of the reactor.

FIG. 12 shows direct current overlap characteristic of the reactor of the embodiment and the existing reactor.

### DETAILED DESCRIPTION OF EMBODIMENTS

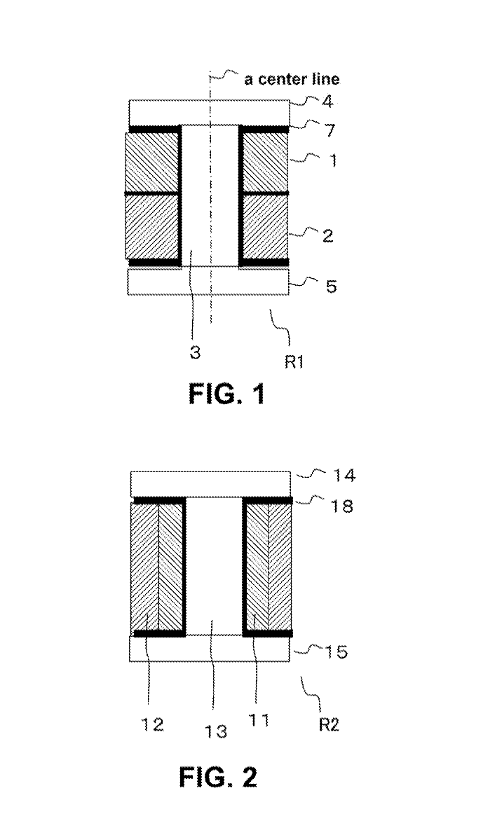

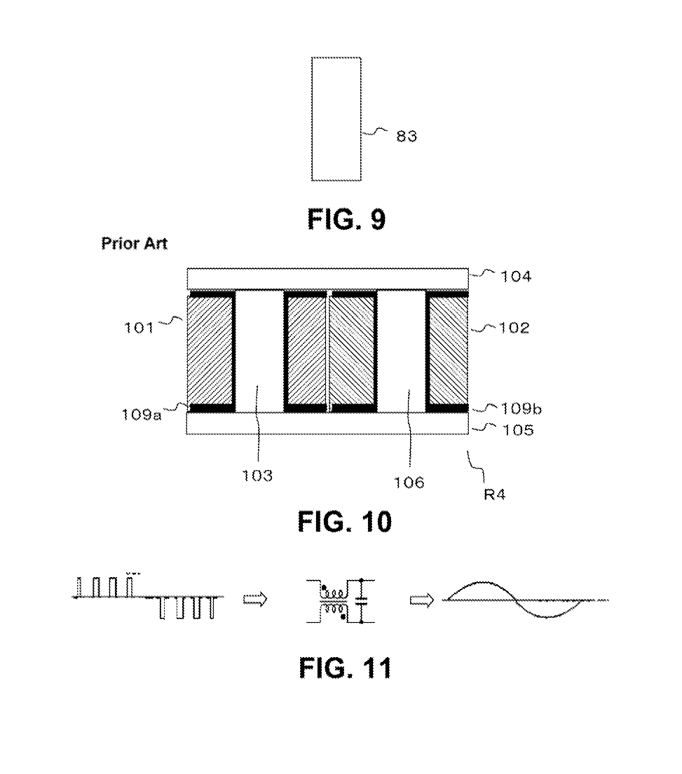

Hereafter, the embodiment of the present invention will be illustrated with reference to the FIG. 1˜FIG. 9. FIG. 1 is a sectioned diagram of the reactor R1 of an embodiment of the present Invention. The reactor R1 comprises a first coil 1, a second coil 2, a first magnetic body 3, a second magnetic body 4, a third magnetic body 5, and a bobbin 7 for dividing coil which is configured with partition.

In the FIG. 1, on the first magnetic body 3 and the bobbin 7 for dividing coil with, partition for assuring insulation from the coil, a pair of coils, which are the first coil 1 and the second coil 2, are wound. Furthermore, each of the divided bobbin is formed into U-shape so that the bobbin 7 for dividing coil with partition can be arranged with the first coil 1 and the second coil 2. Furthermore, the divided bobbin becomes integrated structure, and the first coil 1 and the second coil 2 become mutually insulated state by the bobbin 7 for dividing coil with partition. That is, the first coil 1 and the second coil 2 are arranged in parallel in the direction of center line of the first magnetic body 3. Furthermore, center line is line segment of the first magnetic body 3, which is the center of the direction of winding the coil of the first magnetic body 3, and its extension. Furthermore, the bobbin 7 for dividing coil with partition is installed around the first magnetic body 3 which comprises a first end portion and a second end portion. Furthermore, the second magnetic body 4 is arranged in the first end portion, the third magnetic body 5 is arranged in the second end portion.

Furthermore, the second magnetic body 4 and the third magnetic body 5 are arranged so as to contact with the first end portion and the second end portion of the first magnetic body 3 respectively, and their width becoming maximum is formed wider than that of the first end portion and the second end portion. Therefore, the second magnetic body 4 and the third magnetic body 5 define the area of the long direction of center line of the coils which is arranged with the first coil 1 and the second coil 2. Furthermore, preferably, the area, in which the width becoming maximum of the second magnetic body 4 and the third magnetic body 5 is wider than the first end portion and the second end portion, is in all direction of entire circumference direction of first magnetic body 3.

However, in the case that in response to the request such as stably fixing and arranging the second magnetic body 4 and the third magnetic body 5, and the second magnetic body 4 and the third magnetic body 5 is formed into the polygon structure, it is possible to become the structure that straight line portion, which is an end portion of the plane forming the polygon structure, at least contacts with the first end portion and the second end portion, and it is also possible to be formed so that the first end portion and the second end portion exist in the inner of the plane which forms the polygon structure. That is, it is possible that the second magnetic body 4 and the third magnetic body 5 form the flange portion. Thus, the first magnetic body 3 has the flange portion corresponding to the first magnetic body 3 surrounded by the coils, and the flange portion is insulated from the pair of coils, so it is possible to improve the inductance of the pair of coils.

Furthermore, in the reactor R1 of the embodiment, two end portion of the first magnetic body 3 are formed without directly facing each other via a space where the first magnetic body 3 does not exist. That is, by becoming the structure of open magnetic circuit, unlike the common core shape forming the close magnetic circuit, the volume of the first magnetic body 3 is reduced. So, compared to the existing technology, it is possible to reduce the electrical power losses of the first magnetic body 3 caused by the magnetic flux arising out of the current flowing in the pair of coils.

Further, in the reactor R1, the first coil 1 and the second coil 2 are arranged in parallel in the direction of center line of the first magnetic body 3, so it is possible to reduce the stray capacitance between the first coil 1 and the second coil 2. Further, center line is line segment of the first magnetic body 3, which is the center of the direction of winding the coil of the first magnetic body 3, and its extension.

Furthermore, in the reactor R1, for example, by using the magnetic body which comprises powder material (for example, iron powder) with high saturation magnetic flux density as the first magnetic body 3, and by using the ferrite, in which saturation magnetic flux density is lower than the first magnetic body 3, but magnetic permeability is higher than the first magnetic body 3, and electrical power losses is lower than the first magnetic body 3, as the second magnetic body 4 and the third magnetic body 5, in the magnetic flux arising out of the current flowing in the pair of coils, because of utilizing the feature that saturation magnetic flux density of the first magnetic body 3, which is arranged in the inner of the coils with great magnetic flux, is high, it is possible to make direct current overlap characteristic of inductance excellent and reduce electrical power losses. Furthermore, it is possible to utilize the feature of ferrite that saturation magnetic flux density of the second magnetic body 4 and the third magnetic body 5 is less than the first magnetic body 3 arranged in the inner of the coils, so that magnetic flux of the second magnetic body 4 and the third magnetic body 5 is less than that of the first magnetic body 3 arranged in the inner of the coils. That is, the second magnetic body 4 and the third magnetic body 5 of different material from the first magnetic body 3 are arranged so as to face the two end portion of the first magnetic body 3, and the magnetic permeability of the second magnetic body 4 and the third magnetic body 5 is higher than the first magnetic body 3. In addition, the second magnetic body 4 and the third magnetic body 5 form the flange portion, because magnetic body extends in the direction on which magnetic flux flows, demagnetization factor is reduced. Thus, it is possible to improve inductance. As a result, saturation magnetic flux density of the first magnetic body is larger than saturation magnetic flux density of the second and the third magnetic body, even if in the case of increasing the current, it is possible that the reactor becomes a reactor in which the saturation magnetic flux density during the alternate current operation is high (that is, direct current overlap characteristic is excellent), and the inductance of the pair of coils is high.

Then, the operation of reactor R1 is illustrated. Input signal is input between one end of each of the pair of coils, and it is possible to get output signal, from between the other end of each of the pair of coils on the basis of the input signal. Here, it is possible that the input signal is consecutive alternate current signal or pulse signal using square wave, or, in the case of using square wave, it is possible to make two sides of plus and minus square wave as the input signal. In the case of making the consecutive alternate current signal as the input signal, it is possible that the output signal is consecutive alternate current signal. Furthermore, in the case of making the pulse signal using square wave as the input signal, between a pair of output ends a condenser is connected, thus, it is possible to become a signal that high frequency component of output signal from between the output end is reduced. Furthermore, even if in the case of making two sides of plus and minus square wave as the input signal, furthermore, by connecting a condenser between a pair of output ends, it is possible to reduce the high frequency component of the output signal, so it is possible to get a desired output signal that the high frequency component (ripple, noise component) is reduced by appropriately adjusting the value of the condenser. Furthermore, in the case of outputting the desired signal, it is possible that a condenser is not connected between the output ends.

Here, when input signal is input between the input end of each of the pair of coils of the first coil 1 and the second coil 2, and the output signal is output from between the output ends of each of the pair of coils, the pair of coils are configured so as to be positively coupled to each other. So it is possible to increase the inductance of the pair of coils.

Here, when input signal is input between the input end of each of the pair of coils of the first coil 1 and the second coil 2 and the output signal is output from between the output ends of each of the pair of coils, the current flows, in the first coil 1 and the second coil 2. At this time, the magnetic flux arises out of the flowing current in the first coil 1 and the second coil 2, but each of the magnetic flux is positively coupled to each other in the reinforcing state. That is, if the inductances of the first coil 1 and the second coil 2 are L1=L2=L respectively, in the manner that the series inductance of the pair of coils comprising the first coil 1 and the second coil 2 is Ls=L1+L2+2m√(L1·L2), the first coil 1 and the second coil 2 are connected. Further, m is the coupling degree of the first coil 1 and the second coil 2 (m is 0˜1).

According to the reactor, because the reactor has a first magnetic body 3 and a pair of mutually insulated coils insulated from the first magnetic body 3 while being arranged so as to surround the first magnetic body 3, and positively coupled to each other in response to a signal input between one end of each coil, and the first magnetic body 3 has a first and a second end portions, and the first and the second end portions are formed without directly facing each other via a space where the first magnetic body 3 does not exist, and on the basis of the input signal input between the one end of each of the pair of coils, an output signal is output from between the other end of each of the pair of coils, in order that it is possible to decrease electrical power losses, the first magnetic body 3 has a first and a second end portions, and the first and the second end portions are formed without directly lacing each other via a space where the first magnetic body 3 does not exist, and the pair of coils are arranged so as to surround the first magnetic body 3, so it is possible to become small sized reactor

Furthermore, the first magnetic body 3 has a flange portion corresponding to the first magnetic body 3 surrounded by the coils, and the flange portion is insulated from the pair of coils, so it is possible to increase inductance of the pair of coils.

Furthermore, because the first coil 1 and the second coil 2 are arranged in parallel in the direction of center line of the first magnetic body, it is also possible to reduce the stray capacitance between the first coil 1 and the second coil 2.

FIG. 2 is a sectioned diagram of the reactor R2 of other embodiment of the embodiment. The point different from FIG. 1 is the structure of a first coil 11, a second coil 12, and bobbin 18, hereafter, the embodiment will be illustrated. Furthermore, the descriptions about the part equivalent with the structure of FIG. 1 are omitted. The reactor R2 comprises, a first coil 11, a second coil 12, a first magnetic body 13, a second magnetic body 14, a third magnetic body 15, and a bobbin 18 without partition.

In the FIG. 2, on the bobbin 18, the coil 11 is wound, furthermore, on it the coil 12 is wound. After winding the first coil 11, in order to reinforce the insulation between the first coil 11 and the second coil 12, it is possible to wind an interlayer tape between the first coil 11 and the second coil 12. Further, the bobbin 18 is formed into U-shape so as to be arranged with the winding first coil 11 and second coil 12, it is possible to realize the insulation of magnetic body and the pair of coils. Furthermore, the bobbin 18 is installed around the first magnetic body 13 comprising a first end portion and a second end portion. Furthermore, the second magnetic body 14 is arranged in the first end portion; the third magnetic body 15 is arranged in the second end portion.

In the reactor, one coil of the pair of coils is wound, and on the one coil the other coil is wound, thus, there is an effect that it is easy to wind the coil. Furthermore, because the pair of coils become overlapped structure, it is possible to make the volume of the magnetic body more small sized.

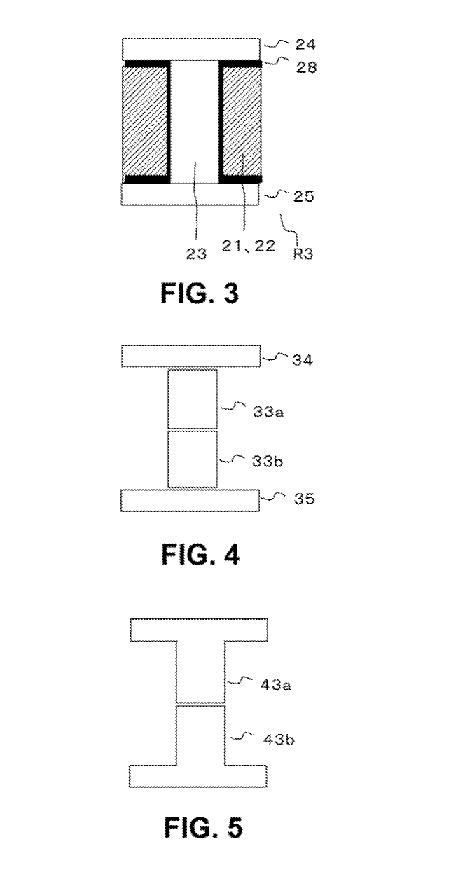

FIG. 3 is a sectioned diagram of the reactor R3 of other embodiment of the embodiment. Furthermore, the descriptions about the part equivalent with the structure of FIG. 1 are omitted. The reactor R3 comprises, a first coil 21, a second coil 22, a first magnetic body 23, a second magnetic body 24, a third magnetic body 25, and a bobbin 28 without partition.

In the FIG. 3, on the bobbin 28, the first coil 21 and the second coil 22 are bifilarly wound. Further, the bobbin 28 is formed into U-shape so as to be arranged with the bifilarly winding first coil 21 and second coil 22. Furthermore, the bobbin 28 is installed around the first magnetic body 23 comprising a first end portion and a second end portion. Furthermore, the second magnetic body 24 is arranged in the first end portion, the third magnetic body 25 is arranged in the second end portion.

In the reactor, the coils are bifilar winding wire, thus, there is an effect that it is easy to wind the coil.

Further, in the reactor R1, the reactor R2, the reactor R3, the first magnetic body has a section of circle, ellipse, square, rectangular, polygon etc., all kinds of shapes which is convenient in manufacture. Furthermore, the second, magnetic body and the third magnetic body could be changed into all kinds of shapes such as block-like shape from board-like shape like circle, ellipse, square, rectangular, polygon and so on. Furthermore, preferably, the area in which the width becoming maximum of the second magnetic body and the third magnetic body is wider than the first end portion and the second end portion of the first magnetic body, is in all direction of entire circumference direction of first magnetic body 3. Furthermore, the preferable maximum periphery of the area wider than the first end portion and the second end portion of the first magnetic body is the same as the maximum periphery of the pair of coils, but it is also possible to be different.

However, in the case that in response to the request such as stably fixing and arranging the second magnetic body and the third magnetic body, and the second magnetic body and the third magnetic body is formed into the square, rectangular, polygon structure, it is possible to become the structure in which straight line portion, which is an end portion of the plane forming the polygon structure, at least contacts with the first end portion and the second end portion, it is also possible to be formed so that the first end portion and the second end portion exist in the inner of the plane which forms the square, rectangular, polygon structure.

FIG. 4˜FIG. 9 are examples of other embodiment of the first magnetic body. In the FIG. 4, in the first magnetic body comprising the first end portion and the second end portion, the second magnetic body 34 is arranged in the first end portion, and the third magnetic body 35 is arranged in the second end portion, furthermore, in the midst of the first magnetic body, the first magnetic body is divided into two parts of a first magnetic body division 1a(33a) and a first magnetic body division 2b(33b) by the plane orthogonal to the center line. Furthermore, it is also possible to divide the first magnetic body into two parts or above. Furthermore, it is also possible that the division portion is not divided equally.

In the FIG. 5, in the first magnetic body comprising the first end portion and the second end portion, the first end portion and the second end portion become the flange portion, furthermore, in the midst of the magnetic body of a part on which the coil is wound, the first magnetic body is equally divided into a first magnetic body division a(43a) and a first magnetic body division b(43b) by the plane orthogonal to the center line. Furthermore, the division place is not limited specially.

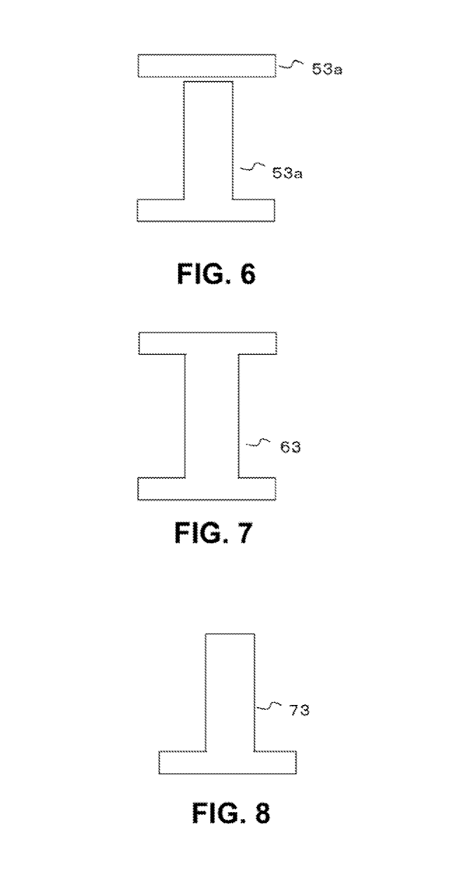

For example, as shown in the FIG. 6, the division is not limited to the midst, and it is possible that in the part which is not the midst of the magnetic body 3, the first magnetic body is divided into a first magnetic body division a(53a) and a first magnetic body division b(53b) by the plane orthogonal to the center line.

Furthermore, in the coil using the first magnetic body, a gap is set in the division portion of the magnetic body, thus, in the case of using large current in the coil, a saturation of the magnetic flux will not occur, so it is possible to reduce the inductance and improve direct current overlap characteristic of the inductance. It is possible to use it and adjust the inductance or direct current overlap characteristic of the inductance, but in the above-mentioned structure, it is possible to adjust the gap of the division portion. Furthermore, in the structure of FIG. 1˜4. FIG. 6, it is possible that the gap is set between the first magnetic body and the second magnetic body and/or the third magnetic body.

In the FIG. 7, in the first magnetic body 63 comprising the first end portion and the second end portion, the first end portion and the second end portion become the flange portion and are integrated structure which are not divided. In this case, in the case of using bobbin, the bobbin is divided in advance, the divided bobbin is arranged around the first magnetic body 63.

In the FIG. 8, in the first magnetic body 73 comprising the first end portion and the second end portion, in any side of the first end portion or the second end portion, the flange portion is arranged.

In the FIG. 9, in the first magnetic body 83 comprising the first end portion and the second end portion, two end portions of the first end portion or the second end portion have not a flange portion.

As above, as shown in the FIG. 1˜FIG. 9, all kinds of deformations are considered, it is possible to combine these deformations respectively.

Furthermore, in the embodiments of FIG. 1˜FIG. 6, it is possible to be a reactor in which in manner of facing the first and the second end portions, a second and a third magnetic body of different material from the first magnetic body are arranged and connected, it is possible to adjust the inductance of the pair of coils.

Furthermore, in the embodiments of FIG. 1˜FIG. 7, the second and the third magnetic body become flange portions corresponding to the first magnetic body covered by the coils, and the flange portions are insulated from the pair of coils, so it is possible to improve the inductance of the pair of coil by the second and the third magnetic body with the flange portions.

### EXAMPLE OF EMBODIMENT 1

Hereafter, the operation of the above-mentioned structure will be illustrated with reference to the example of embodiment of the FIG. 1. Firstly, the structure of the reactor of the FIG. 10 will be illustrated. Furthermore, FIG. 10 is a sectioned diagram of the existing reactor R4.

In the FIG. 10 on the first magnetic body a(103) and the bobbin 109a having the insulation performance for assuring insulation from the coil, the first coil 101 is wound. On the first magnetic body b(106) and the bobbin 109b having the insulation performance for assuring insulation from the coil, the second coil 102 is wound. Here, the bobbin 109a, 109b are formed into U-shape so as to be arranged with the first coil 101 and the second coil 102 respectively. The bobbin 109a having the insulation performance is installed around the first magnetic body a(103), the bobbin 109b having the insulation performance is installed around the first magnetic body b(106). Furthermore, the first coil 101 and the second coil 102 become a mutually insulated state by different winding wires in each place in different space, respectively. Furthermore, on one end of the first magnetic body a(103) and one end of the first magnetic body b(106), the third magnetic body 104 is arranged; on the other end of the first magnetic body a(103) and the other end of the first magnetic body b(106), the fourth magnetic body 105 is arranged.

The first coil 101 and the second coil 102 are a pair of coils positively coupled to each other in response to a signal input between one end of each coil. If the inductances of the first coil 101 and the second coil 102 are L1=L2=L respectively, because each of the coils is far away, the coupling degree is low. In the case that the coupling degree m is 0.5, the series inductance of the pair of coils is Ls=L1+L2+2m√(L1·L2)=3L.

The first coil 1 and the second coil 2 of the FIG. 1 of the embodiment are a pair of coils positively coupled to each other in response to a signal input between one end of each coil. The FIG. 11 is a circuit example using the reactor.

A switching waveform as shown in FIG. 11 generated in an inverter portion of a power conditioner for solar power generation etc. is input between one end of the first coil 1 and the second coil 2 of the reactor, and is output through the condenser connected between the other end of the first coil 1 and the second coil 2. Inputted waveform is an aggregate of rectangle wave which is PWM modulated (pulse width modulated). Here, actually inputted switching waveform, wherein its frequency is 15 kHz, input voltage is 380V, is input between the input end of the first coil 1 and the second coil 2. At this time, the magnetic flux arising out of the current flowing in the first coil 1 and the second coil 2 is positively coupled to each other in the reinforcing state. That is, equivalently, the first coil 1 and the second coil 2 are series-connected. In the embodiment, the pair of coils, that is, the first coil 1 and the second coil 2 are wound closely, so the coupling degree m of the first coil 1 and the second coil 2 is large and becomes about m=0.9. In the embodiment, in the case that m is 0.9, Ls=3.8L, in the case of the same number of turns, the ratio of inductance is 3:3.8 (about 26.7% larger).

In the example of embodiment, the coupling degree of between the pair of coils positively coupled to each other can be 0.8 or above. In the case that the coupling degree m is 0.8, the series inductance of the pair of coils is Ls=L1+L2+2m√(L1·L2)=3.6L, in the case of the same number of turns, the ratio of inductance is 3:3.6. There is an effect that it is possible to improve the inductance of the pair of coils positively coupled to each other by increasing the coupling degree.

In the case that the series inductance of the pair of coils is the same, in the case of the embodiment, it is possible to reduce the number of turns. So, the reactor using the structure as below is made out. The example of the reactor of the embodiment is equivalent with the structure of the FIG. 2, the first coil 11 has 52 turns (φ1 mm 1 layer 52 turns 9 layer connected in parallel), the second coil 12 has 52 turns (φ1 mm 1 layer 52 turns 9 layer connected in parallel). Furthermore, the first magnetic body 13 in the coil portion is a magnetic body which is obtained by dividing a bar-like magnetic body of φ26 mm 75 mm length into three parts (φ26 mm 25 mm length respectively), in which initial magnetic permeability is 120, saturation magnetic flux density is 1290 mT. The second magnetic body 14 and the third magnetic body 15 are both cuboids and are both 46 mm×46 mm×8 mm, in which initial magnetic permeability is 2200, saturation magnetic flux density is 540 mT. Furthermore, each end portion of each of the first magnetic body, the second magnetic body and the third magnetic body is arranged so as to contact.

In the example of the existing reactor, the first coil 101 has 52 turns (φ1 mm 1 layer 52 turns 9 layer connected in parallel), the second coil 102 has 52 turns (φ1 mm 1 layer 52 turns 9 layer connected in parallel). Furthermore, the first magnetic body (103,106) in the coil portion is a magnetic body which is obtained by dividing a bar-like magnetic body of φ24 mm 60 mm length into three parts (φ24 mm 20 mm length respectively), in which initial magnetic permeability is 100, saturation magnetic flux density is 1600 mT. The second magnetic body 104 and the third magnetic body 105 are both cuboids and are both 70 mm×24 mm×20 mm, in which initial magnetic permeability is 100, saturation magnetic flux density is 1600 mT.

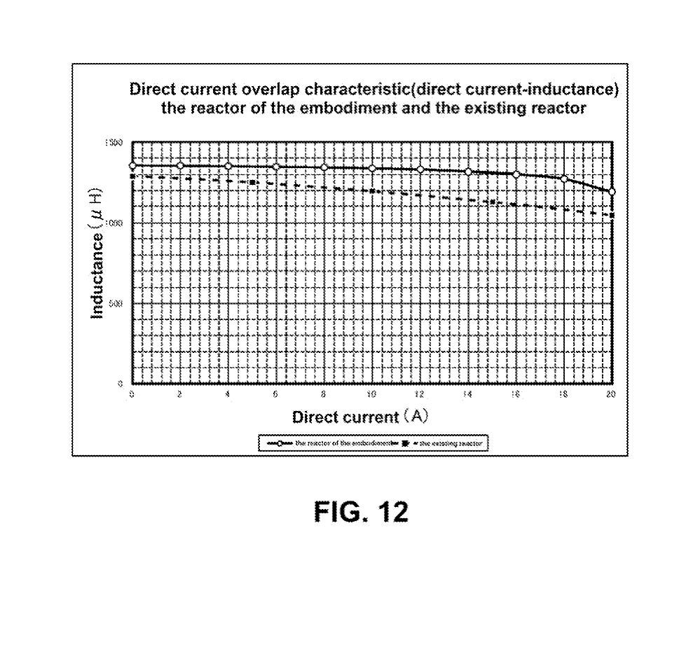

FIG. 12 is the comparative example of direct current overlap characteristic (current-inductance) of the reactor using the structure of the FIG. 2 of the embodiment and the existing reactor. In the reactor of the embodiment, regardless of using the coil of the same number of turns, the inductance of the pair of coils is large. In the existing reactor, along with increasing the current, the inductance of the pair of coils declined gradually, but in the reactor of the embodiment, along with increasing the current, the decrease of the inductance of the pair of coils is little. In the reactor of the embodiment, the volume of the magnetic body used at this time is 121487 mm³, in the existing reactor, the volume of the magnetic body used at this time is 78676 mm³, it is possible to reduce the volume of the core about 40%. Furthermore, in the reactor of the embodiment, the efficiency of the reactor is 99.50%, in the existing reactor, the efficiency of the reactor is 99.43%, the efficiency of the reactor of the embodiment is excellent, that is, electrical power losses are low. As a result, it is possible to become a small-sized reactor in which the volume of the core is reduced, and the electrical power losses are reduced.

Furthermore, in the case that the first magnetic body is not divided into 3 parts, and is formed by one magnetic body, it becomes the same result. Furthermore, the input signal is PWM signal (pulse width modulation signal) having plus and minus pulse signal of 15 kHz cycle as shown in the FIG. 11, the output signal is sine wave signal of 50 Hz (Sin signal).

Even if in the embodiment disclosed by the FIG. 2, it is possible that the coupling degree of between the pair of coils positively coupled to each other is 0.8 or above. In the case that the coupling degree m is 0.8, the series inductance of the pair of coils is Ls=L1+L2+2m√(L1·L2)=3.6L, in the case of the same number of turns, the ratio of inductance is 3:3.6. There is an effect that it is possible to improve the inductance of the pair of coils positively coupled to each other by increasing the coupling degree.

Furthermore, even if in the case of increasing the current, it is possible that the reactor becomes a reactor in which the saturation magnetic flux density during the alternate current operation is high (that is, direct current overlap characteristic is excellent), and the inductance of the pair of coils is high.

The current flows in the first coil 1 and the second coil 2 by the switching waveform input in the reactor of the FIG. 1, and the magnetic flux arising out of it passes through the first magnetic body which is in the inner side of the first coil 1 and the second coil 2, and flows from the second magnetic body 4 connected in the first end portion, via a space where magnetic body does not exist, and gets back to the first magnetic body through the third magnetic body 5 from the second end portion. At this time, via the space where magnetic body does not exist, it is possible to reduce the electrical power because the electrical power losses of the magnetic body, through which the magnetic flux existing in the existing reactor passes, do not appear, and it is possible to reduce the magnetic body of the part where magnetic body does not exist. That is, in order that the reactor is possible to decrease electrical power losses, the first magnetic body has a first and a second end portions, and the first and the second end portions are formed without directly facing each other via a space where the first magnetic body does not exist, and because of reducing the volume of the magnetic body and the pair of coils being arranged so as to surround the first magnetic body, it is possible to get an effect that the reactor becomes small sized reactor. Thus, it is possible to realize material reduction, small-size, and high efficiency.

Furthermore, saturation magnetic flux density of the first magnetic body is larger than that of the second and the third magnetic body, magnetic permeability of the first magnetic body is smaller than that of the second and the third magnetic body, thus, ever if in the case of increasing the current, there is also an effect that the reactor becomes a reactor in which the saturation magnetic flux density during the alternate current operation is high (that is, direct current overlap characteristic is excellent), and the inductance of the pair of coils is high.

Furthermore, as the configuration example of the embodiment, for the insulation of the magnetic body and coil, the case comprising the bobbin is mentioned, but it is also possible to coat the magnetic body by epoxy resin, etc, for insulation and not to use the bobbin. Furthermore, by only using the insulated coating of the winding wire to get insulation, it is also possible to become a structure which does not use the insulation coating of the magnetic body.

As the preferable other embodiment of the embodiment, it can become a electrical device having the reactor. As a circuit having the reactor, there is a circuit which makes the switching waveform smooth, etc. Furthermore, as a device comprising the circuit, there is power conditioner or inverter power source, DC-DC converter, etc., which is possible to become all kinds of electrical devices.

### DESCRIPTION OF REFERENCE NUMERALS

1 a first coil
2 a second coil
3 a first magnetic body
4 a second magnetic body
5 a third magnetic body
7 a bobbin for dividing coil with partition
11 a first coil
12 a second coil
13 a first magnetic body
14 a second magnetic body
15 a third magnetic body
18 a bobbin without partition
21 a first coil
22 a second coil
23 a first magnetic body
24 a second magnetic body
25 a third magnetic body
28 a bobbin without partition
33a a first magnetic body division a
33b a first magnetic body division b
34 a second magnetic body
35 a third magnetic body
43a a first magnetic body division a
43b a first magnetic body division b
53a a first magnetic body division a
53b a first magnetic body division b
63 a first magnetic body
73 a first magnetic body
83 a first magnetic body
101 a first coil
102 a second coil
103 a first magnetic body a
104 a second magnetic body
105 a third magnetic body
106 a first magnetic body b
109a a bobbin of the existing reactor
109b a bobbin of the existing reactor
R1 a reactor R1 of the embodiment
R2 a reactor R2 of the embodiment
R3 a reactor R3 of the embodiment
R4 a reactor R4 of the embodiment

1. A reactor comprising a first magnetic body and a pair of mutually insulated coils insulated from the first magnetic body while being arranged so as to surround the first magnetic body, and positively coupled to each other in response to a signal input between one end of each coil, the first magnetic body has a first and a second end portions, and the first and the second end portions are formed without directly facing each other via a space where the first magnetic body does not exist, and an output signal is output from between the other end of each of the pair of coils on the basis of the input signal input between the one end of each of the pair of coils.

2. The reactor of claim 1, wherein,
one coil of the pair of coils is covered by the other coil.

3. The reactor of claim 1, wherein,
the pair of coils are arranged in parallel in the direction of center line of the first magnetic body.

4. The reactor of claim 1, wherein,
the pair of coils are bifilar winding wire.

5. The reactor of claim 1, wherein, the first magnetic body has a flange portion corresponding to the first magnetic body surrounded by the coils, and the flange portion is insulated from the pair of coils.

6. The reactor of claim 1, wherein, in manner of facing the first and the second end portions, a second and a third magnetic body of different material from the first magnetic body are arranged and connected.

7. The reactor of claim 6, wherein,
the second and the third magnetic body become a flange portion corresponding to the first magnetic body covered by the coils, and the flange portions are insulated from the pair of coils.

8. The reactor of claim 6, wherein,
the saturation magnetic flux density of the first magnetic body is larger than that of the second and the third magnetic body, the magnetic permeability of the first magnetic body is smaller than that of the second and the third magnetic body.

9. The reactor of claim 1, wherein,
the input signal is a plurality of plus and minus pulse signals, and the output signal is alternate current signal.

10. The reactor of claim 1, wherein,
the coupling degree between the pair of coils positively coupled to each other is 0.8 or above.

11. A electrical device comprising the reactor of claim 1.
